(19) United States
(12) Patent Application Publication
(10) Pub. No.: US 2004/0181606 A1
(43) Pub. Date: Sep. 16, 2004

(54) Method for controlling an exchange

(76) Inventors: Jens Astor, Muenchen (DE); Steffen Rusitschka, Muenchen (DE); Markus Schmidt, Nuernberg (DE); Horst Schreiner, Fuerth (DE); Alan Southall, Muenchen (DE); Gudrun Zahlmann, Neumarkt (DE)

Correspondence Address: HARNESS, DICKEY & PIERCE, P.L.C., P.O.BOX 8910, RESTON, VA, 20195, US

(21) Appl. No.: 10/769,869

(22) Filed: Feb. 3, 2004

(30) Foreign Application Priority Data
Feb. 3, 2003 (DE) 10304277.6

(51) Int. Cl. G06F 15/173

(52) U.S. Cl. 709/238; 709/244

(57) ABSTRACT

A method is for controlling an exchange in a data transmission system, in which information demand data from information demanders and information supply data representing information which can be supplied by various information suppliers are compared in order to ascertain corresponding information demand data and information supply data. After a successful preliminary comparison for particular minimum matches, the information demand data in question are first transmitted to a data comparison device associated with the information supplier in question for the purpose of a more detailed comparison with the information represented by the information supply data. Upon receipt of positive comparison result data from the data comparison device, indicating that the information which can be supplied matches the information demand data, the exchange then transmits corresponding search result data to a terminal belonging to the information demander.

The present application hereby claims priority under 35 U.S.C. §119 on German patent application number DE 103 04 277.6 filed Feb. 3, 2003, the entire contents of which are hereby incorporated herein by reference.

### FIELD OF THE INVENTION

The invention generally relates to a method for controlling an automatic exchange in a data transmission system. Preferably, it relates to one where firstly information demand data, which have been transmitted to the exchange by information demanders, and secondly information supply data, which have been transmitted to the exchange by information suppliers and which represent information which can be supplied by the respective information supplier, are received. They are then compared in order to ascertain corresponding information demand data and information supply data. Finally, search result data are transmitted to a terminal belonging to an information demander if the information demand data from the information demander correspond with the information supply data from an information supplier.

The invention also generally relates to a corresponding automatic exchange system and to an exchange for carrying out such a method

### BACKGROUND OF THE INVENTION

An example of a data transmission system in which suitable exchanges can be used for automatically performing mediation processes in the aforementioned manner are networks which include a number of computers or servers positioned at arbitrary locations, such as the Internet or an intranet inside an organization. The users of such data transmission systems are normally connected to the system by way of appropriately equipped terminals, e.g. terminals equipped with suitable interface cards, PCs, laptops, mobile radios, PDAs etc., and can use the terminals to transmit arbitrary data to the system or to retrieve them from the system.

In recent years, such data transmission systems particularly the Internet—have increasingly also been used for trade in goods and services. In this case, in a first place, the suppliers of goods or services can present themselves on “web pages” which are technically implemented, by way of example, on a server belonging to the supplier himself, which server is connected to the data transmission system or is part of the data transmission system, or belonging to a provider associated with the supplier. The potential customers (subsequently also called demanders) can call up these web pages using the data transmission system and can thus obtain information about the supplier and his supply options and can order goods or services directly.

If a demander is looking for a particular good or service, he firstly has the option of using, as a simple exchange, a “search engine” which uses indicated search terms, i.e. in this case the demand data, to show all the web pages found which are correlated to these search terms. Secondly, a demander can also use exchanges within the data transmission system which have been provided for such a purpose. These are special devices which are usually implemented in the form of software modules on one or more networked servers and which are essentially used to present firstly supply data from a very wide variety of suppliers of a particular good or service and secondly demand data from the individual demanders, to compare them with one another and to ensure the smoothest possible mediation between suppliers and demanders. Such exchanges are also called “virtual marketplaces” on account of their function similar to a real marketplace.

Such virtual marketplaces are described, by way of example, in WO 97/26612 A1. In this specification, an agent system is used to access various marketplaces. This involves every user having an associated personal agent. In this context, a software agent is to be understood to mean a device which is capable of performing various delegated electronic actions for the user or for another agent. The advantage of this agent system is, inter alia, that use of the agents allows a demander to be anonymously active on a wide variety of markets in order to compare and assess a wide variety of products and to buy products.

A fundamental problem of all previously known exchanges arises, however, when the goods for which the demander is looking for a suitable supplier are valuable information, such as demographic information obtained and compiled with a great deal of effort, patient data, information about industrial property rights, etc. Unlike in the case of a material product, such as a television, computer or else a particular known piece of software, here the scope of what the demander ultimately receives from the supplier in the event of a purchase is not obvious from the outset.

Before the deal is concluded, the demander therefore generally wishes to know as precisely as possible what information he can receive from the supplier, in order to ensure that it is actually the information he wants. On the other hand, the supplier cannot actually transmit the information to the demander or make it generally available to the exchanges prior to a binding agreement about, the deal, because the information is of value only while it is not generally known and cannot be obtained by the demander at any time without any actual payment to the supplier. When the aforementioned exchanges are used to find information suppliers, the demanders are currently dependent on their trusting the supplier, for example because they already know the supplier from previous purchases of information or have received recommendations for this supplier from other demanders.

### SUMMARY OF THE INVENTION

It is an object of an embodiment of the present invention to specify a method for controlling an automatic exchange or an automatic exchange system in a data transmission system, where the mediation process itself provides a very simple way of ensuring that the demander purchases the information from the supplier only when it is information which the demander wants, without the need for the supplier to make the information available to the demander beforehand.

An object may be achieved by a method and by an automatic exchange system, or by an exchange.

In line with an embodiment of the invention, this may involve, upon discovery of a pair including information demand data from an information demander and information supply data from an information supplier which have at least a prescribed minimum measure of correspondence at least in particular parts, the information demand data: in question first being transmitted to a data comparison device associated with the information supplier in question for the purpose of performing a more detailed comparison there with the information represented by the information supply data. Only upon receipt of positive comparison result data from the data comparison device, indicating that the information which can be, supplied matches the information demand data, does the exchange transmit corresponding search result data to the terminal belonging to the information demander.

That is to say, instead of an ordinary single comparison between the information supply data and the information demand data, in this case a two-stage method is carried out. A first positive preliminary comparison, in which it has been established that the information which can be supplied might be able to meet the requirements of the demander in line with the information demand data transmitted by the demander, is finally followed by the performance of a more precise comparison. Further, this: is done by directly accessing the information which can be supplied. This comparison is performed using a data comparison device associated with the information supplier, i.e. the information is not transmitted to the information demander. This ensures that the information which can be supplied keeps its value for the supplier, and secondly the demander can be relatively certain that he is receiving information which meets his requirements.

An automatic exchange system for carrying out such a method needs to have an exchange which, besides a number of demander interface, devices for receiving information demand data from the information demanders and for sending search results to the information demanders, has a number of supplier interface devices for receiving the information supply data from the information suppliers. It further includes a comparator unit for comparing the information demand data and the information supply data and also a control unit which prompts the transmission of search results to the terminal belonging to an information demander if the information demand data from the information demander in question correspond to the information which can be supplied by an information supplier.

In line with an embodiment of the invention, the control device must in this case be in a form such that, upon discovery of a pair including information demand data from an information demander and information supply data from an information supplier which have at least a certain prescribed minimum measure of correspondence at least in particular parts, it first prompts the transmission of the information demand data in question to a data comparison device associated with the information supplier in question for the purpose of a more detailed comparison with the information represented by the information supply data. Further, only upon receipt of positive comparison results does it accordingly prompt the transmission of the search results to the terminal belonging to the information demander,

If the exchange finds a plurality of information supply data from various information suppliers during the preliminary comparison which have the prescribed minimum measure of correspondence to the information demand data from an information demander in the desired parts, the information demand data are preferably respectively transmitted in parallel to the data comparison devices associated with the information suppliers in question and there is then a wait for the data comparison devices to return the comparison result data. In this case, the search result data transmitted from the exchange to the information demander's terminal preferably contain information about all the information supply data matching the information demand data and/or about the associated information suppliers. With particular preference, the search result data also contain information about those areas in which and/or to what extent the information which can be supplied and the information demand data correspond.

In addition, the exchange preferably has demander functional units respectively associated with the various information demanders for the purpose of first receiving the information demand data from the information demanders and automatically forwarding them to the exchange. Conversely, these demander functional units can receive the search result data transmitted by the exchange for the information demander in question and can sort and normalize the information supply data contained in the search result data and/or data about the information supplier prior to transmission to the information demander or his terminal. In particular, this allows price details to be normalized in order to make it easier for the demander to compare the different supply options. In this context, the demander functional units can be of similar design and can have similar functionalities to the personal agents in WO 97/26612 mentioned at the outset.

In the same way, the various information suppliers can each have associated supplier functional units for the purpose of first receiving the information supply data from the associated information suppliers and automatically forwarding them to the exchange, These supplier functional units can also receive the information demand data transmitted by the exchange which match the information supply data from the information supplier, and can prompt the detailed comparison with the information represented by the information supply data by the associated data comparison device. These supplier functional units can also be designed in a similar manner to the aforementioned personal software agents.

In another preferred exemplary embodiment, the information demand data are anonymized prior to forwarding to the exchange or prior to forwarding to a data comparison device associated with an information supplier. This can be done by a number of anonymization units. This may be just a single anonymization unit which, by way of example, is implemented in the exchange as a software module and first anonymizes the incoming data before they are processed further and/or transmitted to the data comparison device. Alternatively, it may involve a plurality of individual anonymization units which are associated with the respective demanders and which are part of the demander functional units associated with the individual demanders, for example.

In the same way, it is also possible to anonymize the information supply data from the information suppliers prior to forwarding to the exchange or prior to transmission to an information demander—for example within search result data. This is done using a number of second anonymization units, which can likewise be a single anonymization software module, for example implemented in the exchange, or else a plurality of anonymization units which are associated with the individual users and are arranged in the supplier functional units used by the suppliers, for example.

In principle, the data comparison devices associated with the individual information suppliers may also be components of the exchange. In this case, however, a particularly secure area must be involved. Thus, the individual suppliers can store their information there without others being able to view this information. The data comparison devices associated with the individual information suppliers may also be, in principle, a number of data comparison devices—in the extreme case just a single data comparison device—which are associated with the individual information suppliers only temporarily for the respective comparison use.

With particular preference, however, the data comparison devices are respectively part of the supplier functional units associated with the information suppliers in question and/or are installed locally to the information suppliers in question, i.e. on a server or terminal arranged there. This has the advantage that the valuable information does not need to be published by the information supplier but rather always remains in the information supplier's area of influence. In this case, however, it should preferably be a certainty that data comparison devices themselves and the flow of the comparison are subject only to the control to the exchange system or the exchange, and cannot be manipulated by the information suppliers. This ensures objective comparison between the information which can be supplied and the demanders information demand data.

### BRIEF DESCRIPTION OF THE DRAWINGS

The present invention will become more fully understood from the detailed description of preferred embodiments given hereinbelow and the accompanying drawings, which are given by way of illustration only and thus are not limitative of the present invention, and wherein:

FIG. 1 shows a schematic overview of an exchange system based on an embodiment of the invention,

FIG. 2 shows a schematic flowchart of a possible flow for a mediation process based on an embodiment of the inventive method.

### DETAILED DESCRIPTION OF THE PREFERRED EMBODIMENTS

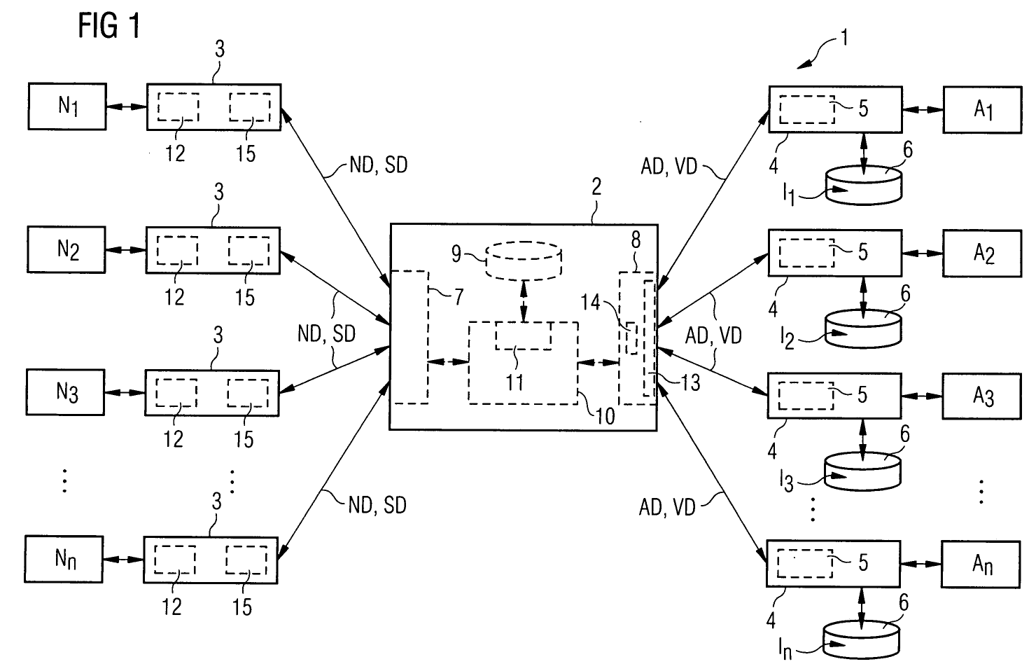

The central component in the automatic exchange system 1 shown in FIG. 1 is an exchange 2. This exchange 2 may be installed, by way of example, on one or more networked servers in the form of hardware and/or software—but preferably for the majority in the form of software modules. In principle, this can also be a virtual marketplace or the like which is already implemented on an Internet server and which additionally has the components or software modules described below or, if it already has, such functionalities, uses them in the inventive manner described below.

It is clear that the exchange 1 may also have further components and functionalities which virtual marketplaces or similar exchanges normally have. Such standard components and functions will not be explained further in the description below or in the figures, however.

In line with an embodiment of the invention, the exchange 2 in this case has a demander interface device 7 which is used to receive information demand data ND from the information demanders N₁ to Nₙ.

In this instance, communication between the information demanders N₁ to Nₙ and the exchange 2 takes place via demander functional units 3 which are part of the exchange system 1. These demander functional units 3, subsequently also called demander agents 3, may be implemented in the form of software modules, for example on one of the servers, on which the exchange 2 is also implemented. Alternatively, the demander agents 3 may also be implemented in the form of software modules on a terminal belonging to the respective information demander N₁ to Nₙ.

As subordinate software modules, such a demander agent 3 firstly contains an anonymization unit 12 which first of all anonymizes the information demand data ND which are input by the information demander N₁ to Nₙ before they are forwarded to the exchange 2, and secondly a data conditioning module 15 for the purpose of conditioning search result data which need to be transmitted from the exchange to the information demander N₁ to Nₙ following a successful search, for example sorting them according to suppliers or normalizing them for pricing. The information demander N₁ to Nₙ is thus able to compare the individual information supply options with one another relatively conveniently.

In the exemplary embodiment shown, the exchange 2 also has a control device 10 which is implemented in the form of a software module on a server. Part of this control unit 10 is a preliminary comparison unit 11 in the form of a software module for comparing information demand data ND and information supply data AD for a match. In addition, the exchange 2 contains a memory 9 for the purpose of buffer-storing the information demand data ND and the information supply data AD there.

The exchange 2, also has a supplier interface device 8 for receiving information supply data AD from various information suppliers A₁ to Aₙ. In a similar manner to in the case of the information demanders N₁ to Nₙ, communication with the information suppliers A₁ to Aₙ takes place via supplier functional units 4, subsequently also called supplier agents 4, in this case too. The supplier agents 4 are installed in the form of software modules on a server belonging to the information supplier A₁ to Aₙ in question.

In the exemplary embodiment shown, the supplier agents 4 each have a data comparison device 5 in the form of a software submodule. This data comparison device 5 is used to compare information demand data ND transmitted from the exchange 2 to the supplier agent 4 with the information 11 to In which can actually be supplied by the information supplier A₁ to Aₙ. This information I₁ to Iₙ is stored in a memory 6 which can be accessed by the respective supplier agent 4.

In the exemplary embodiment shown, the supplier agents 4 and hence also the data comparison device 5 are automatically installed on the server belonging to the respective information supplier At to An by an agent manager 14 in the comparison device 2. In this case, the data comparison device 5 is in a form such that it cannot be altered by the respective information supplier A₁ to Aₙ and performs the comparison in line with the stipulations made by the exchange 2 or by the operator of the exchange 2. This variant firstly ensures that the respective information suppliers A₁ to Aₙ do not have to publish their valuable information I₁ to Iₙ and secondly an objective comparison between the information which can be supplied and the information demand data ND from the individual information demanders N₁ to Nₙ is performed.

In the exemplary embodiment shown, the supplier interface device 8 in the exchange 2 also has an anonymization module 13 which first of all anonymizes information supply data AD sent from the information suppliers A₁ to Aₙ to the exchange 2.

The anonymization ensures for each party at least during the preliminary comparison, that the individual information demanders and information suppliers can look for a suitable “partner” without it being general knowledge, particularly for competitors, what type of information the individual information demanders N₁ to Nₙ are looking for and what type of information the information suppliers A₁ to Aₙ can supply.

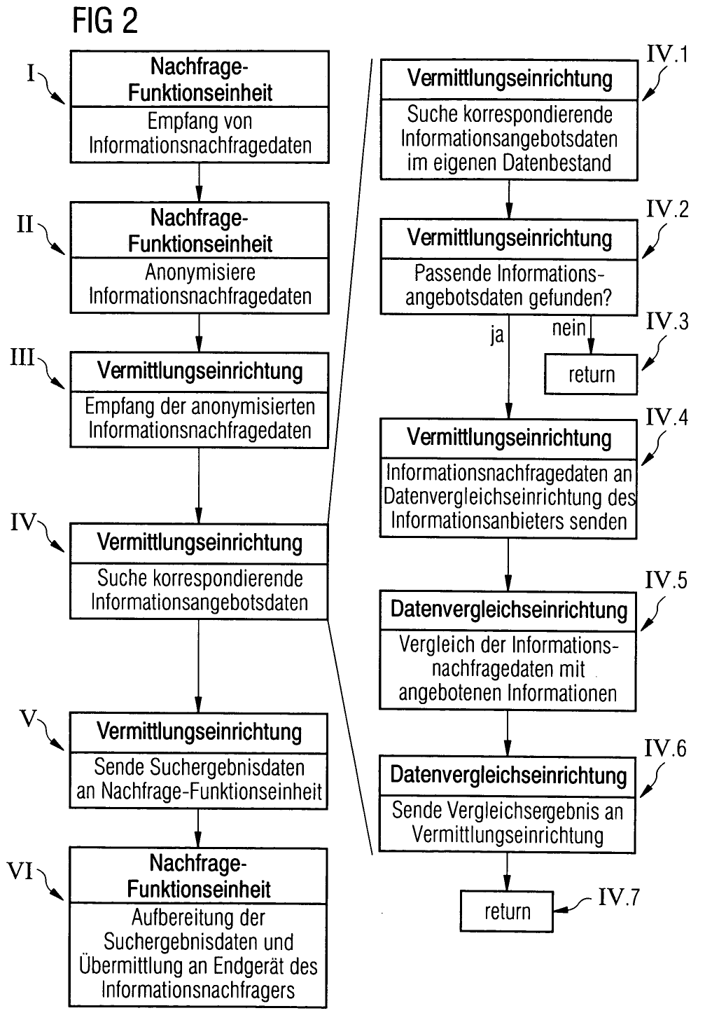

A typical method flow when mediating between an information supplier and an information demander in line with the inventive method is explained in more detail below with reference to the flowchart shown in FIG. 2. The top part of the individual process blocks names the respective functional unit which performs or prompts the individual process step.

For the purposes of illustration, the example taken as a basis here is that of a pharmaceutical company requiring patient data relating to a particular type of illness and attempting to find a supplier, for example a clinic, which has these patient data. In this context, it is assumed that the individual clinics have already taken it upon themselves to use their supplier agents 4 to send the exchange 2 corresponding information supply data AD, which have been stored in the memory 9 in the exchange 2. These information supply data AD contain just a few parameters which indicate what information is involved. By way of example, the information supply data can state that data relating to a particular illness are available, possibly from what period of time these data originate and what volume of data is available. In this case, the information supply data should firstly be extensive enough for it to be possible to perform a useful preliminary comparison with information demand data from the individual data demanders N₁ to Nₙ, and secondly these information supply data AD must not give away too much about the information I₁ to Iₙ which can actually be supplied since the information I₁ to Iₙ represents the actual value, of course.

The flowchart in FIG. 2 starts with a first method step I, in which the demander functional unit 3 contains the information demand data m from the information supplier A₁ to Aₙ. This demander functional unit 3 uses its anonymization module 12 to anonymize the information demand data ND and then forwards the anonymized information demand data ND to the exchange 2 (method step II),

When the exchange 2 has received the, anonymized information demand data ND in method step III, corresponding information supply data AD are Sought in method step IV. In line with the invention, this search process V is divided into a plurality of subprocesses which are shown in detail in the right-hand column in FIG. 2.

In the first search method step V.1, the exchange 2 looks for corresponding information supply data AD in its own stock of data at first, i.e. a preliminary comparison between the information demand data ND and the information supply data AD, stored in the memory 9, from the individual information suppliers A₁ to Aₙ is performed. If this preliminary comparison provides a positive result and if matching information supply data AD are found in method step IV.2, then the exchange 2 sends the information demand data to the data comparison device 5 belonging to the information supplier or suppliers A₁ to Aₙ in question in the next method step IV.4. Otherwise, execution returns to the main routine in method step IV.3.

The information demand data ND sent to the individual data comparison devices 5 belonging to the potential information suppliers A₁ to Aₙ in the event of success are compared therein with the information I₁ to Iₙ which can actually be supplied. In the specific exemplary embodiment, in which a pharmaceutical company is looking for patient data, the information demand data ND sent to the comparison device 2 by the pharmaceutical company are distributed over the individual hospitals, which are able to supply information relating to the illness in question from the desired period of time etc. in line with their information supply data AD. The individual clinics, whose computer systems have the supplier agents 4 with the data comparison devices 5 installed in them, then perform a comparison—without the patient data leaving the secure area of the clinic up to this time. This involves going through all the necessary data types which may be of interest to the pharmaceutical company individually step by step, i.e. the information demand data ND from the pharmaceutical company are compared in detail with the information I₁ to Iₙ which can be supplied.

in method step 1V. 6, the comparison result data VD are then returned to the exchange 2, and finally execution returns to the main routine in method step IV.7.

The comparison result data VD contain, by way of example, more precise information about the extent to which, possibly even precisely which parts of, the respective information I₁ to Iₙ actually cover(s) the information request. These may simply be values which state that, by way of example, the information request can be met to a particular percentage, or else they may contain more precise information, for example that the information relating to the particular illness is also available on a sex-specific basis or just for particular age groups, for example for children only.

In the case of a positive comparison result, i.e. if the comparison result has achieved a match above a prescribed threshold, for example, the control unit 10 prompts corresponding search result data SD to be returned to the demander agent 3 belonging to the information demander N₁ to Nₙ in question.

Within the demander agent 3, the data conditioning module 15 is then used to condition the search result data SD. Thus, by way of example, if the exchange 2 has had multiple success and has found a plurality of information suppliers A₁ to Aₙ whose information I₁ to Iₙ might match the information demand data ND from the respective information demander, then the individual supply options can be sorted and, if appropriate, also normalized, The search result data SD conditioned in this manner are then sent to the terminal, generally a PC or server, belonging to the information demander N₁ to Nₙ.

In this case, the search result data may also already contain information about the respective information supplier. In another variant, the information suppliers A₁ to Aₙ are still anonymous up to this time, and only if the information demander N₁ to Nₙ is interested in the respective information I₁ to Iₙ is direct contact set up between the information demander N₁ to Nₙ and the information supplier A₁ to Aₙ in question, for example via the exchange 2. In addition, it is also possible for the information to be exchanged and the payment to be made completely anonymously using the exchange 2, in which case the exchange 2 needs to be equipped as appropriate such that it has the necessary payment functionalities for the information demander N₁ to Nₙ to make the required payment before he receives the information I₁ to Iₙ from the information supplier A₁ to Aₙ or from the exchange 2. A wide variety of methods for ensuring secure payment using a data transmission system such as the Internet are known to the person skilled in the art.

Finally, it will once again be pointed out that the system architecture and method flow shown in the figures are merely exemplary embodiments which can be varied by the person skilled in the art within a wide scope without departing from the area of an embodiment of the invention.

Thus, by way of example, the anonymization modules 12 or the data conditioning modules 15 may also be implemented centrally in the exchange 2 instead of in the individual demander agents 3. Conversely, the anonymization module 13 may also be respectively implemented in the form of individual modules in the supplier agents 4. In addition, both the exchange 2 and the terminals used at the information demander ends and information supplier ends can have appropriate encryption devices so that all the data are transmitted between the information demanders and the exchange and also between the information suppliers and the exchange and vice versa—but particularly the valuable information which is co be transferred—only in encrypted form so as to prevent unauthorized access by third parties.

In addition, the exchange 2—in contrast, to the situation shown in the figures—may also have, by way of example, separate demander interface devices for receiving information demand data (ND) from the information demanders and for sending search result data (SD) to the terminals belonging to the information demanders in question, Or may accordingly have separate supplier interface devices (8) for receiving information supply data (AD) from the information suppliers and for sending information demand data (ND) to the data comparison devices (5) belonging to the various information suppliers (A₁ to Aₙ).

Instead of patient data relating to a particular type of illness, demographic data, for example customer data, may also be involved, in particular, which a company wishes to purchase in order to take these data as a basis for performing a consumer analysis which is then used to provide better orientation for its own supply option.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for controlling an exchange in a data transmission system, comprising:
receiving information demand data transmitted from information demanders to the exchange;
receiving information supply data transmitted from information suppliers to the exchange, and representing information supplyable by the respective information supplier;
comparing the information demand data and the information supply data to ascertain corresponding information demand data and information supply data;
transmitting search result data to a terminal belonging to an information demander if the information demand data from the information demander correspond to the information supply data from an information supplier, wherein, upon discovery of a pair including information demand data from an information demander and information supply data from an information supplier having at least a prescribed minimum measure of correspondence at least in particular parts,
the information demand data in question are first transmitted to a data comparison device associated with the information supplier in question for the purpose of a more detailed comparison with the information represented by the information supply data, and only upon receipt of positive comparison result data from the data comparison device, indicating that the supplyable information matches the information demand data, does the exchange transmit corresponding search result data to the terminal belonging to the information demander.

2. The method as claimed in claim 1, wherein, upon discovery of a plurality of information supply data from various information suppliers having at least a prescribed minimum measure of correspondence to the information demand data from an information demander at least in particular parts, the information demand data in question are respectively transmitted to the data comparison devices associated with the various information suppliers and, upon receipt of a plurality of comparison result data from the data comparison devices, the search result data transmitted from the exchange to the terminal belonging to the information demander contain information about at least one of all of the information supply data matching the information demand data and about the associated information suppliers.

3. The method as claimed in claim 1, wherein at least one of the comparison result data and the search result data contain information about at least one of the areas and the measure in which the information supplyable and the information demand data correspond.

4. The method as claimed in claim 1, wherein an information demander first transmits the information demand data to a demander functional unit associated with the information demander, and the information demand data are at least in part automatically forwarded from there to the exchange.

5. The method as claimed in claim 1, wherein the information demand data are anonymized at least one of prior to forwarding to the exchange and prior to forwarding to a data comparison device belonging to an information supplier.

6. The method as claimed in claim 5, wherein an information supplier first transmits the information supply data to a supplier functional unit associated with the information supplier, and wherein at least one of the information supply data are at least in part forwarded automatically from there to the exchange and the exchange transmits information demand data matching the information supply data from the information supplier to the supplier functional unit, which prompts the more detailed comparison with the information represented by the information supply data by the associated data comparison device.

7. The method as claimed in claim 6, wherein the information supply data are anonymized at least one of prior to forwarding to the exchange and prior to transmission to an information demander.

8. An automatic exchange system in a data transmission system, comprising:
a plurality of demander interface devices for receiving information demand data, transmitted from information demanders to an exchange, and for sending search result data to terminals belonging to the information demanders;
a plurality of supplier interface devices for receiving information supply data, transmitted from information suppliers to the exchange and representing information supplyable by the respective information supplier;
a comparison unit for comparing the information demand data and the information supply data to ascertain corresponding information demand data and information supply data;
a control unit for prompting the transmission of search result data to the terminal belonging to an information demander if the information demand data from the information demander correspond to the information supply data from an information supplier, wherein the control unit, upon discovery of a pair including information demand data from an information demander and information supply data from an information supplier having at least a prescribed minimum measure of correspondence at least in particular parts, first prompts the transmission of the information demand data to a data comparison device associated with the information supplier for the purpose of a more detailed comparison with the information represented by the information supply data, and only upon receipt of positive comparison result data from the data comparison device, indicating that the supplyable information matches the information demand data, the control unit prompts the transmission of corresponding search result data to the terminal belonging to the information demander.

9. The exchange system as claimed in claim 8, further comprising demander functional units, respectively associated with the various information demanders, for at least one of first receiving the information demand data from the associated information demanders and automatically forwarding them to the exchange and for receiving from the exchange search result data for the information demander in question and at least one of sorting and normalizing at least one of information supply data, contained in the search result data, and information supplier data prior to transmission to the information demander.

10. The exchange system as claimed in claim 8, further comprising a plurality of anonymization units for anonymizing the information demand data at least one of prior to forwarding to the exchange and prior to forwarding to a data comparison device belonging to an information supplier.

11. The exchange system as claimed in claim 8, further comprising supplier functional units respectively associated with the various information suppliers, for at least one of first receiving the information supply data from the association information suppliers and automatically forwarding them to the exchange and for receiving from the exchange information demand data matching the information supply data from the information supplier and prompting the more detailed comparison with the information represented by the information supply data by the associated data comparison device.

12. The exchange system as claimed in claim 10, further comprising a plurality of second anonymization units for anonymizing the information supply data at least one of prior to forwarding to the exchange and prior to forwarding to an information demander.

13. The exchange system as claimed in claim 8, wherein the data comparison devices associated with the individual information suppliers are each at least one of part of the supplier functional units associated with the information suppliers in question and are arranged locally to the information supplier in question.

14. An exchange for an automatic exchange system, comprising:
a plurality of demander interface devices for receiving information demand data, transmitted from information demanders to the exchange, and for sending search result data to terminals belonging to the information demanders;
a plurality of supplier interface devices for receiving information supply data, transmitted from information suppliers to the exchange and representing information supplyable by the respective information supplier;
a comparison unit for comparing the information demand data and the information supply data to ascertain corresponding information demand data and information supply data;
a control unit for prompting the transmission of search result data to the terminal belonging to an information demander if the information demand data from the information demander correspond to the information supply data from an information supplier, wherein the control unit, upon discovery of a pair including information demand data from an information demander and information supply data from an information supplier having at least a prescribed minimum measure of correspondence at least in particular parts, first prompts the transmission of the information demand data to a data comparison device associated with the information supplier for the purpose of a more detailed comparison with the information represented by the information supply data, and only upon receipt of positive comparison result data from the data comparison device, indicating that the supplyable information matches the information demand data, the control unit prompts the transmission of corresponding search result data to the terminal belonging to the information demander.

15. The method as claimed in claim 2, wherein at least one of the comparison result data and the search result data contain information about at least one of the areas and the measure in which the information supplyable and the information demand data correspond.

16. The method as claimed in claim 4, wherein the exchange transmits the search result data to the demander functional unit, which at least one of sorts and normalizes at least one of information supply data contained therein and associated information supplier data prior to transmission to the information demander.

17. The method as claimed in claim 2, wherein an information demander first transmits the information demand data to a demander functional unit associated with the information demander, and the information demand data are at least in part automatically forwarded from there to the exchange.

18. The method as claimed in claim 2, wherein the exchange transmits the search result data to the demander functional unit, which at least one of sorts and normalizes at least one of information supply data contained therein and associated information supplier data prior to transmission to the information demander.

19. An automatic exchange system in a data transmission system, comprising:
demander interface means for receiving information demand data, transmitted from information demanders to the exchange, and for sending search result data to terminals belonging to the information demanders;
supplier interface means for receiving information supply data, transmitted from information suppliers to the exchange and representing information supplyable by the respective information supplier;
comparison means for comparing the information demand data and the information supply data to ascertain corresponding information demand data and information supply data; and
control means, upon discovery of a pair including information demand data from an information demander and information supply data from an information supplier having at least a prescribed minimum measure of correspondence at least in particular parts, for first prompting the transmission of the information demand data to a data comparison device associated with the information supplier for the purpose of a more detailed comparison with the information represented by the information supply data, and only upon receipt of positive comparison result data from the data comparison device, indicating that the supplyable information matches the information demand data, for prompting the transmission of corresponding search result data to the terminal belonging to the information demander.

20. A method for controlling an exchange in a data transmission system, comprising:
comparing information demand data from information demanders and information supply data, representing supplyable information from various information suppliers, to ascertain corresponding information demand data and information supply data;
determining whether or not the comparison produces at least a minimum number of matches; and
transmitting information demand data in question to a data comparison device associated with an information supplier in question upon the comparison producing at least the minimum number of matches;
performing a more detailed comparison at the data comparison device with the information represented by the information supply data;
indicating that the supplyable information matches the information demand data upon receipt of a positive comparison result data from the data comparison device; and
transmitting corresponding search result data to a terminal belonging to the information demander.

21. The exchange system as claimed in claim 9, further comprising a plurality of anonymization units for anonymizing the information demand data at least one of prior to forwarding to the exchange and prior to forwarding to a data comparison device belonging to an information supplier.

22. The exchange system as claimed in claim 9, further comprising supplier functional units respectively associated with the various information suppliers, for at least one of first receiving the information supply data from the association information suppliers and automatically forwarding them to the exchange and for receiving from the exchange information demand data matching the information supply data from the information supplier and prompting the more detailed comparison with the information represented by the information supply data by the associated data comparison device.

23. The exchange system as claimed in claim 10, further comprising supplier functional units respectively associated with the various information suppliers, for at least one of first receiving the information supply data from the association information suppliers and automatically forwarding them to the exchange and for receiving from the exchange information demand data matching the information supply data from the information supplier and prompting the more detailed comparison with the information represented by the information supply data by the associated data comparison device.

24. The exchange system as claimed in claim 11, further comprising a plurality of second anonymization units for anonymizing the information supply data at least one of prior to forwarding to the exchange and prior to forwarding to an information demander.
